(19) United States
(12) Patent Application Publication
(10) Pub. No.: US 2010/0223976 A1
(43) Pub. Date: Sep. 9, 2010

(54) HIGH FLOW RATE PROVER AND METER FOR CUSTODY TRANSFER MEASUREMENT

(76) Inventor: Peter P. Jakubenas, Rosenberg, TX (US)

Correspondence Address: WILLIAMS, MORGAN & AMERSON, 10333 RICHMOND, SUITE 1100, HOUSTON, TX, 77042, US

(21) Appl. No.: 12/399,370

(22) Filed: Mar. 6, 2009

(51) Int. Cl. G01F 25/00; G01F 1/708

(52) U.S. Cl. 73/1.16; 73/861.05

(57) ABSTRACT

A method includes introducing a tag into a fluid stream, the tag being suspended in the fluid stream. The tag is detected at a first end of a calibrated volume and a first detection signal is generated responsive thereto. The tag is detected at a second end of the calibrated volume and a second detection signal is generated responsive thereto. A flow parameter for the fluid stream is determined based the first and second detection signals and the calibrated volume.

### CROSS-REFERENCE TO RELATED APPLICATIONS

Not applicable.

### BACKGROUND

The disclosed subject matter relates generally to hydrocarbon production and transportation and, more particularly, to a high flow rate prover and meter for custody transfer measurement.

In the hydrocarbon industry, meters are employed to measure large quantities of fluid, such as oil, that are transferred from one entity to another (e.g., a custody transfer). Generally, the accuracy of a meter may be affected by the characteristics of the metered fluid, such as viscosity, specific gravity, temperature, and pressure. Meters are proven under normal operating conditions to provide traceability of the meter registration to an internationally recognized volumetric or gravimetric standard. Typically, a prover is used in conjunction with a meter prior to or during a custody transfer to calculate a meter factor that is applied to correct the meter's measurements. The meter factor relates the meter output at operating conditions to the certified standard. The measured quantity times the meter factor represents the actual quantity delivered.

A conventional prover employs an elastomer sphere that passes through a section of pipe in series with the meter. High integrity block and bleed valves are employed to switch the prover into and out of the fluid stream to facilitate proving. A high integrity four-way valve is used to reverse the flow in a bi-directional prover. A somewhat complex interchange valve and launching device is used to pass the sphere in a uni-directional prover. The sphere passes between two detectors or sensors. The distance the sphere traverses between the sensors defines a known volume. Hence, by counting high resolution (typically 10,000 or more) meter pulses during traversal of the sphere, the precise number of meter pulses per calibrated volume and thus a meter factor may be determined. Proving may involve a uni-directional or bi-directional movement of the sphere.

To prove a large diameter ultrasonic meter (e.g., 10-24 inches or larger), a conventional uni- or bi-directional prover would be very large, have a prohibitively high cost, and would be difficult and expensive to maintain. Presently, multiple smaller meter runs and a smaller prover are used. This arrangement is necessitated by velocity limits imposed on provers due to hydraulic considerations in starting, stopping, diverting, and reversing the large mass of the sphere and fluid.

As the price of crude oil and refined products increases, the need for accurate proving is increased. Mis-measurement of even 0.05% on a stream flowing at 2,000 BPH or 48,000 BPD of $90 crude oil can result in an error of $790,000 per year. Under-registration deprives the company of entitled revenue, and over registration raises the issue of customer complaints or retroactive rebates.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that includes introducing a tag into a fluid stream, the tag being suspended in the fluid stream. The tag is detected at a first end of a calibrated volume and a first detection signal is generated responsive thereto. The tag is detected at a second end of the calibrated volume and a second detection signal is generated responsive thereto. A flow parameter for the fluid stream is determined based on the first and second detection signals and the calibrated volume.

Another aspect of the disclosed subject matter is seen is a proving system including piping for carrying a fluid stream, a meter, a tag insertion unit, first and second tag sensors, and a control unit. The meter is operable to generate pulses, each pulse representing a volume of fluid flowing through the meter. The tag insertion unit is operable to introduce a tag into the fluid stream, the tag being suspended in the fluid stream. The first tag sensor is operable to detect the tag at a first end of a calibrated volume defined in the piping and generate a first detection signal. The second tag sensor is operable to detect the tag at a second end of the calibrated volume and generate a second detection signal. The control unit is operable to count the pulses from the meter between the first and second detection signals to determine a measured pulse count and generate a meter correction factor for the meter based on the measured pulse count and the calibrated volume.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified diagram of an illustrative embodiment of a meter and proving system;

FIGS. 2 and 3 are diagrams illustrating embodiments of tag sensors used in the proving system of FIG. 1;

FIG. 4 is a graph illustrating detections generated by a group of tags passing through a tag sensor;

FIGS. 5 and 6 are diagrams illustrating other embodiments of a tag sensor used in the proving system of FIG. 1;

FIG. 7 is a diagram of an alternative embodiment of a meter and proving system employing redundant meters; and

FIG. 8 is a diagram of an illustrative embodiment of a flow metering system employing tag sensors.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

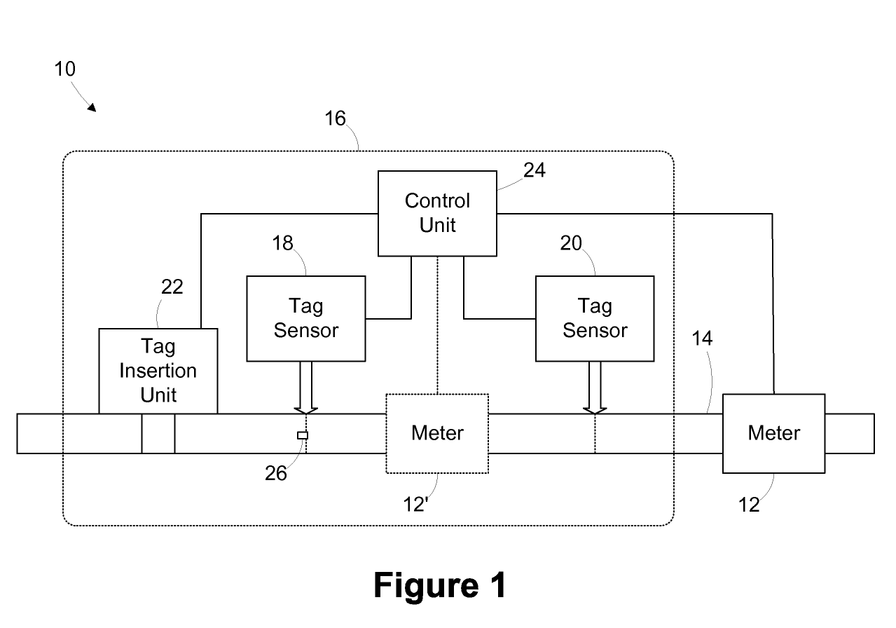

Referring now to the drawings wherein like reference numbers correspond to similar components throughout the several views and, specifically, referring to FIG. 1, the disclosed subject matter shall be described in the context of a flow metering system 10. The flow metering system 10 may be employed to facilitate custody transfers of petroleum fluids (e.g., liquid or gas). The flow metering system 10 includes a meter 12 installed in piping 14. A prover 16 is implemented using two tag sensors 18, 20, a tag insertion unit 22, and a control unit 24.

In general, the tag insertion unit 22 introduces a tag 26 into the production fluid (e.g., liquid, gas, or mixed) passing through the piping 14 at the request of the control unit 24. The control unit 24 measures high resolution pulses from the meter as the tag 26 traverses between the tag sensors 18, 20 to determine a number of meter pulses representative of the prover calibrated volume. The determined pulses are compared to the nominal pulses of the meter 12 to generate a meter factor to be applied to the meter 12. The control unit 24 may be implemented using various devices, such as a flow computer coupled to the tag sensors 18, 20, the meter 12, and the tag insertion unit 22. The control unit 24 may be a programmable device executing software to perform the function described herein.

The prover 16 may be employed with relatively large diameter (e.g., 10 inch or greater), high flow rate metering applications. Such applications would otherwise require very large, expensive conventional provers. The prover 16 may be used with a variety of meter types, such as an inferential ultrasonic meter, a positive displacement meter, or a turbine meter.

The position of the tag sensors 18, 20 in the piping 14 relative to the meter 12 may vary. Although the tag sensors 18, 20 are illustrated upstream of the meter 12, they may be installed downstream of the meter 12, or they may straddle the meter 12, as illustrated in FIG. 1 by the meter 12′. In an embodiment, where the meter 12′ is between the tag sensors 18, 20, the prover 16 may be sold as a metering package including the meter 12′. The length of piping 14 required to implement the proving function may vary depending on the diameter of the piping 14, and the calibrated displaced volume required to meet testing standards and repeatability. For example, a 3-6 diameter spacing may be provided between the tag insertion unit 22, and a spacing of 15-25 diameters may be provided between the tag sensors 18, 20 to constitute the calibrated volume.

The section of piping 14 between the between the tag sensors 18, 20 represents a calibrated volume. The bore of the piping 14 in the prover 16 may be ground and coated with a corrosion resistant coating to protect the validity of the known volume. The volume may be calibrated offline using conventional water draw displacement techniques using a sphere or cylindrical pig including one or more tags 26 for triggering the sensors 18, 20. The prover 16 may be temporarily isolated from the production stream using valves to allow calibration, or alternatively, the piping run including the prover 16 may be disconnected and rolled out of the line for calibration.

The control unit 24 uses the calibrated volume in conjunction with signals from the tag sensors 18, 20 to determine the pulses per volume and flow rate of fluid passing through the prover 16 and the meter 12 being proved. The flow rate is determined by dividing the calibrated volume by the tag traversal time. The meter factor is determined by dividing the prover calibrated volume by the pulses measured by the meter 12. The calculation may also be corrected for the effects of temperature, pressure, and specific gravity on the fluids and the materials of construction of the meter 12 and prover 16 per American Petroleum Institute (API) standards. Techniques for performing these corrections are known to those of ordinary skill in the art, so they are not described in greater detail herein. Because the tags 26 are suspended in the fluid stream, they do not introduce variations in the flow rate, as is common in conventional provers that employ displacers that must be pushed through the piping.

To implement a proving cycle, the control unit 24 signals the tag insertion unit 22 to inject a tag 26 into the process fluid. The first tag sensor 18 detects the presence of the tag 26 and sends a detection signal to the control unit 24. The control unit 24 initiates a pulse counter and timer upon receipt of the first detection signal. When the tag 26 passes the second tag sensor 18, the control unit 24 receives a second detection signal and terminates the pulse counter and timer. Based on the pulses collected and tag traversal time tracked by the control unit 24, the meter registered volume and/or flow rate of the fluid may be determined. The proving cycle may include the injection and pulse counting and timing of multiple tags 26 to demonstrate repeatability.

There are various techniques that may be employed to implement the tags 26 and associated tag sensors 18, 20. In one embodiment, the tags 26 may be radio frequency identification (RFID) tags. Generally, RFID tags include an integrated circuit and an antenna. An RFID tag may be passive (i.e., uses power from the detection signal to answer the detector) or active (i.e., uses on-board battery power to answer the detector). In the illustrated embodiment, passive RFID tags may be used as they might introduce more benign materials into the process fluid as compared to an active tag.

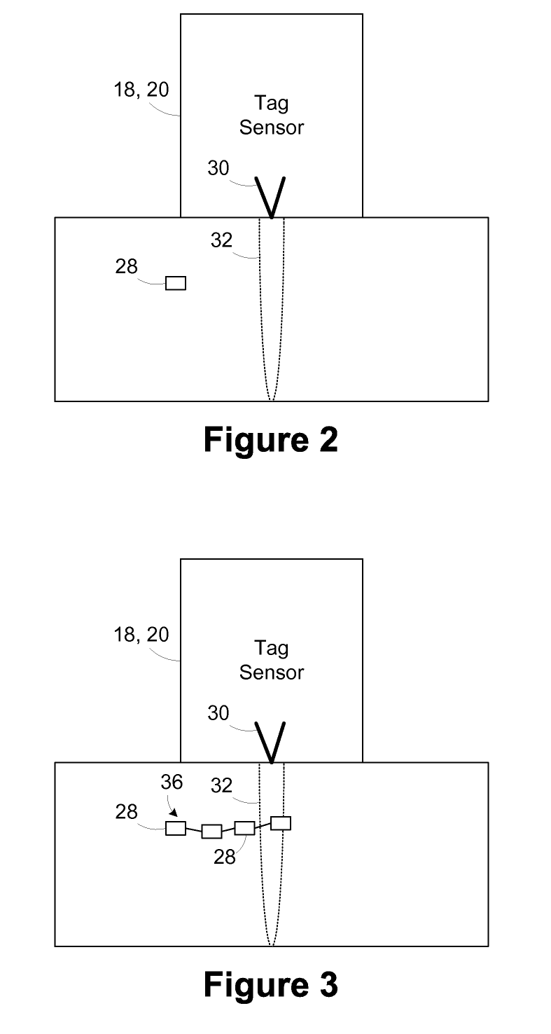

FIG. 2 illustrates a portion of the prover 16 including one of the tag sensors 18, 20 to illustrate the detection of an RFID tag 28. Each RFID tag 28 may have a unique identification code. The tag sensor 18, 20 includes one or more antennas 30 that broadcast an interrogation signal that spans at least a portion of the piping 14, as designated by a detection field 32. The antennas 30 may be implemented as directional antennas with appropriate shielding that functions to shape the detection field 32. Shaping the detection field 32 provides a more accurate detection region to allow detections to more closely match the start and end of the calibrated volume.

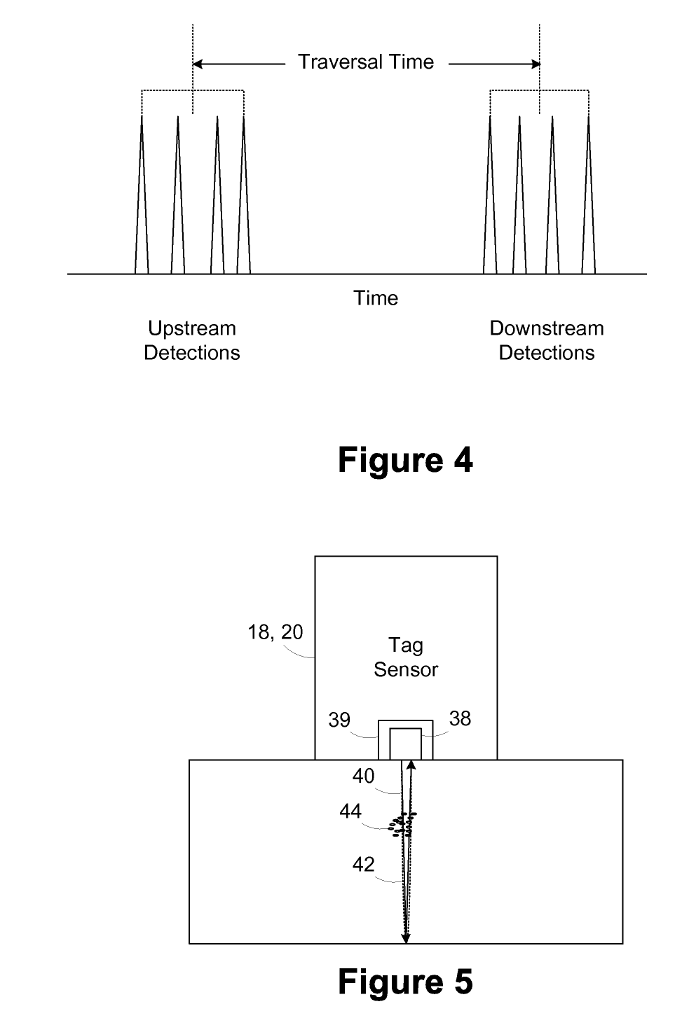

In some embodiments, a string 36 of RFID tags 28 may be used, as shown in FIG. 3. The string 36 allows multiple detections to be provided for each proving run. The string 36 of tags 28 may be coupled to one another, as shown in FIG. 3, or alternatively, the string 36 may be generated by inserting a quantity of tags 28 in succession, such that they are in close proximity to one another. The detection stream at the upstream sensor 18 may be compared to the detection stream at the downstream sensor 20. For example, as illustrated in FIG. 4, the centers of the detection streams from the sensors 18, 20 may be used as the timing references for the calibrated volume.

In another embodiment, the tags 26 may be implemented by injecting a volume of a tag material (e.g., liquid or solid) into the process stream. The sensors 18, 20 may be configured to detect the presence of the tag material particles at the boundaries of the calibrated volume. The particular type of sensor employed depends on the nature of the tag material. For example, an optical sensor may be used to detect a fluorescent, colored, or reflective material, or a radiation detector may be used to detect a radioactive material.

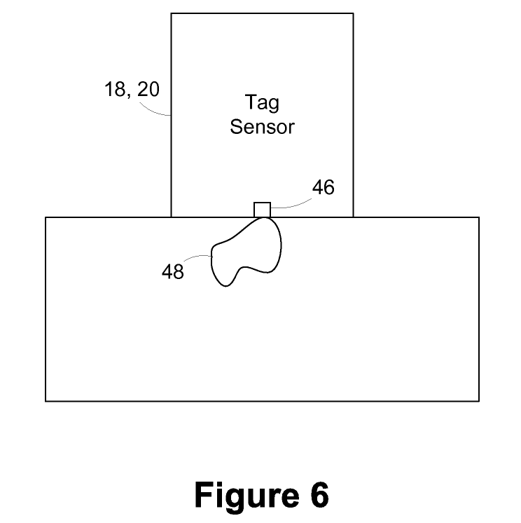

One example of an optical detection technique is illustrated in FIG. 5. A light source 38 directs a beam 40 (e.g., a laser beam) through the piping 14 and monitors the reflection profile. Because a light source, such as a laser, may emit a very narrow beam, the resulting detection field 42 may be extremely narrow, resulting in increased accuracy. Of course, the wavelength and intensity of the light source may vary depending on the particular embodiment, and the beam may or may not be in the visible spectrum. A tag 44 including reflective particles is introduced into the process fluid. When the reflective tag 44 is illuminated by the light source 38, the magnitude of the reflected light intensity may change significantly. For example, in one embodiment, the light source 38 may be reflected by the bottom of the piping 14 back to a detector. The reflective particles may tend to scatter a portion of the light, resulting in a lower intensity at a detector 39. The detection of the tag 44 may be identified by the drop in reflected light intensity. In another embodiment, the light source 38 may not be aligned with the detector 39, so that the normal monitored light intensity may be very small. In such a case, the detection of the tag 44 may be triggered when the monitored light intensity increases due to the light scattered from the reflective tag 44 that now impinges on the detector.

It is also contemplated that other types of waveforms may be used in lieu of or in addition to light based waveforms. For example, sonic, ultrasonic, or radio waves may be used to detect the presence of the tags 26 based on a similar broadcast/reflection technique.

In yet another embodiment illustrated in FIG. 6, the tags 26 may be implemented using a material that is different than the process fluid. For example, the tag 26 may be a quantity of dye. A probe 46 may monitor the process stream. When particles of a tag material 48 (e.g., liquid or solid) pass the probe 46, they are detected based on the color. The dye may be mixed throughout the process fluid or may exist as a slug of colored material (e.g., as shown in FIG. 6). The particular nature of the probe may vary depending on the particular type of tag material 48 used.

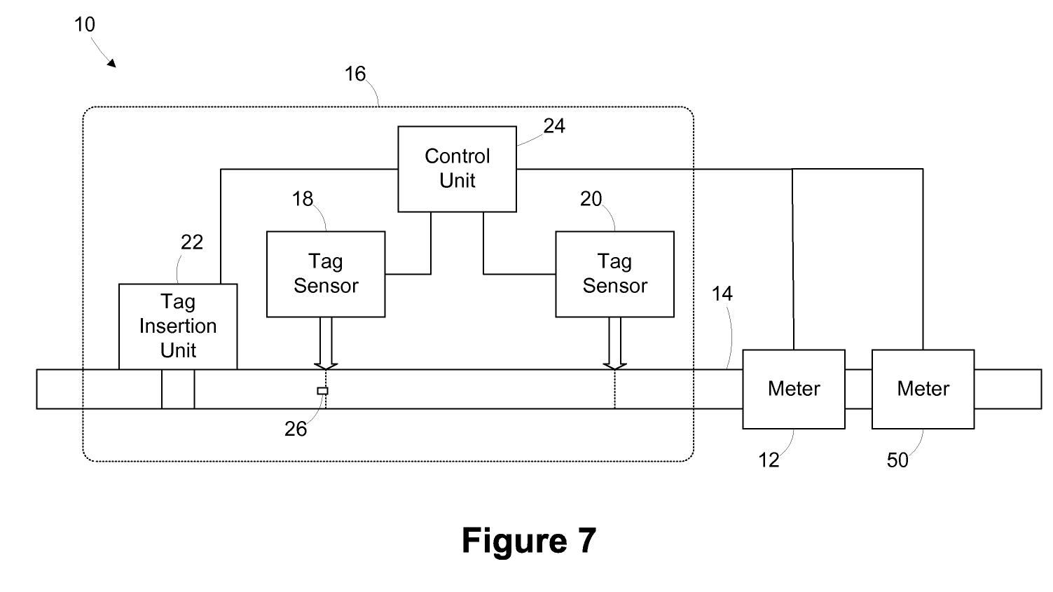

FIG. 7 illustrates another embodiment of the present subject matter, where the prover 16 may be implemented in conjunction with a second meter 50. The second meter 50 may be the same type or a different type than the first meter 12. The second meter 50 may be used to identify problems associated with repeatability in the proving of the meter 12.

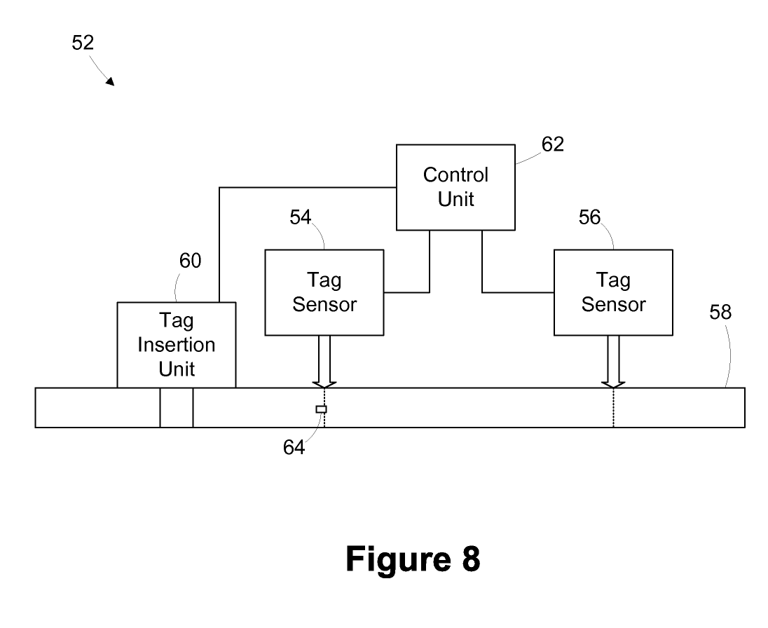

Because, the prover 16 provides a measure of flow rate, the detection techniques may also be applied to provide metering functionality without the use of an actual meter. As shown in FIG. 8, a metering system 52 may be implemented using two tag sensors 54, 56 coupled to piping 58, a tag insertion unit 60, and a control unit 62. Tags 64 may be periodically injected by the tag insertion unit 60 into the process fluid passing through the piping 58 at a predetermined rate corresponding to the sampling rate of the metering system 52. The tags 64 may be detected by the sensors 54, 56 to determine a traversal time. Again, the piping 58 between the sensors 54, 56 represents a calibrated volume that may be divided by the tag traversal time to determine a flow rate. The control unit 62 may synthesize meter pulses based on the determined flow rate and incorporate a meter correction factor based on temperature, pressure, and specific gravity. In one example, the metering system 52 may be used when a meter that normally measures the flow rate is out of service. In this manner, a transfer may continue while repairs are conducted. In such a case, the metering system 52 may act as a prover during normal operation, and as a metering device when the associated meter is unavailable.

The proving techniques described herein have various advantages over conventional provers. The prover 16 may be implemented for larger piping diameters than may be serviced by a conventional prover due to hydraulic limits on conventional provers. The prover 16 also allows the elimination of the multiple meter runs, associated high integrity valves and instruments, and the large quantity of pipe, and fittings associated with a typical prover. Instead, the prover 16 may be installed in the upstream and downstream piping that is already reserved for the meter 12.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A proving system, comprising:
piping for carrying a fluid stream;
a meter operable to generate pulses, each pulse representing a volume of fluid flowing through the meter;
a tag insertion unit operable to introduce a tag into the fluid stream, the tag being suspended in the fluid stream;
a first tag sensor operable to detect the tag at a first end of a calibrated volume defined in the piping and generate a first detection signal;
a second tag sensor operable to detect the tag at a second end of the calibrated volume and generate a second detection signal; and
a control unit operable to count the pulses from the meter between the first and second detection signals to determine a measured pulse count and generate a meter correction factor for the meter based on the measured pulse count and the calibrated volume.

2. The system of claim 1, wherein a nominal pulse count associated with the meter represents a volume corresponding to the calibrated volume, and the control unit is operable to divide the nominal pulse count by the measured pulse count to generate the meter correction factor.

3. The system of claim 1, wherein the meter is disposed between the first and second tag sensors.

4. The system of claim 1, wherein the meter comprises an inferential meter.

5. The system of claim 1, wherein the tag comprises a radio frequency identification (RFID) tag, and the first and second tag sensors comprise RFID sensors.

6. The system of claim 5, wherein the tag comprises a plurality of RFID tags, the first tag sensor is operable to generate a first plurality of detections corresponding to the plurality of RFID tags, the second tag sensor is operable to generate a second plurality of detections corresponding to the plurality of RFID tags, and the control unit is operable to determine a reference point on each of the first and second pluralities of detections and determine the flow parameter based on the reference points and the calibrated volume.

7. The system of claim 1, wherein the tag comprises a tag material, and the first and second tag sensors are operable to detect the tag material in the fluid stream.

8. The system of claim 7, wherein the tag material comprises liquid.

9. The system of claim 7, wherein the tag material comprises reflective particles, and the first and second tag sensors each comprise a light source and a light detector.

10. The system of claim 9, wherein the light source comprises a visible spectrum light source.

11. The system of claim 7, wherein the tag material is radioactive, and the first and second tag sensors each comprise a radiation detector.

12. A method, comprising:
introducing a tag into a fluid stream, the tag being suspended in the fluid stream;
detecting the tag at a first end of a calibrated volume and generating a first detection signal responsive thereto;
detecting the tag at a second end of the calibrated volume and generating a second detection signal responsive thereto; and
determining a flow parameter for the fluid stream based the first and second detection signals and the calibrated volume.

13. The method of claim 12, further comprising:
counting pulses from a meter between the first and second detection signals to determine a measured pulse count, each pulse representing a volume of fluid flowing through the meter;
generating a meter correction factor for the meter based on the measured pulse count and the calibrated volume.

14. The method of claim 13, wherein a nominal pulse count associated with the meter represents a volume corresponding to the calibrated volume, and generating the meter correction factor further comprises dividing the nominal pulse count by the measured pulse count.

15. The method of claim 12, further comprising:
determining an elapsed time between the first and second detection signals; and
determining a flow rate of the fluid stream based on the elapsed time and the calibrated volume.

16. The method of claim 12, wherein the tag comprises a radio frequency identification (RFID) tag.

17. The method of claim 16, wherein the tag comprises a plurality of RFID tags, and the method further comprises:
generating a first plurality of detections corresponding to the plurality of RFID tags passing the first end;
generating a second plurality of detections corresponding to the plurality of RFID tags passing the second end;
determining a reference point on each of the first and second pluralities of detections; and
determining the flow parameter based on the reference points and the calibrated volume.

18. The method of claim 12, wherein the tag comprises a tag material, and detecting the tag at the first and second ends of the calibrated volume comprises detecting the tag material in the fluid stream.

19. A metering system, comprising:
piping for carrying a fluid stream;
a tag insertion unit operable to introduce a tag into the fluid stream, the tag being suspended in the fluid stream;
a first tag sensor operable to detect the tag at a first end of a calibrated volume defined in the piping and generate a first detection signal;
a second tag sensor operable to detect the tag at a second end of the calibrated volume and generate a second detection signal; and
a control unit operable to determine a flow parameter for the fluid stream based the first and second detection signals and the calibrated volume.

20. The system of claim 19, wherein the control unit is operable to generate meter pulses indicative of a flow rate of the fluid stream, each pulse representing a volume of fluid, wherein the control unit is operable to determine an elapsed time between the first and second detection signals and generate the meter pulses incorporating a meter correction factor based on the elapsed time and the calibrated volume.

21. The system of claim 19, wherein the tag comprises a radio frequency identification (RFID) tag, and the first and second tag sensors comprise RFID sensors.

22. The system of claim 21, wherein the tag comprises a plurality of RFID tags, the first tag sensor is operable to generate a first plurality of detections corresponding to the plurality of RFID tags, the second tag sensor is operable to generate a second plurality of detections corresponding to the plurality of RFID tags, and the control unit is operable to determine a reference point on each of the first and second pluralities of detections and determine the flow parameter based on the reference points and the calibrated volume.

23. The system of claim 19, wherein the tag comprises a tag material, and the first and second tag sensors are operable to detect the tag material in the fluid stream.

24. The system of claim 23, wherein the tag material comprises liquid.

25. The system of claim 23, wherein the tag material comprises reflective particles, and the first and second tag sensors each comprise a light source and a light detector.

26. The system of claim 25, wherein the light source comprises a visible spectrum light source.

27. The system of claim 23, wherein the tag material is radioactive, and the first and second tag sensors each comprise a radiation detector.
